(19) United States
(12) Patent Application Publication
(10) Pub. No.: US 2026/0216545 A1
(43) Pub. Date: Jul. 30, 2026

(54) HIGH FORCE BOOSTER ACTUATOR

(71) Applicant: Tyco Fire Products LP, Cranston, RI (US)

(72) Inventors: Joel Allen Clishe, Marinette, WI (US); Alexander Starzynski, Marinette, WI (US); Austin C. Hower, Menominee, MI (US); Adam Michaud, Menominee, MI (US)

(73) Assignee: Tyco Fire Products LP, Cranston, RI (US)

(21) Appl. No.: 19/147,543

(22) PCT Filed: Mar. 18, 2024
(86) PCT No.: PCT/IB2024/052612

§ 371 Date: Jul. 11, 2025

Related U.S. Application Data
(60) Provisional application No. 63/491,394, filed on Mar. 21, 2023.

(51) Int. Cl. A62C 35/68; A62C 35/02

(52) U.S. Cl. CPC A62C 35/68; A62C 35/02

(57) ABSTRACT

A tank assembly for a fire suppression system includes a storage tank to store a fire suppressant, a valve coupled with the storage tank, the valve to release the fire suppressant, an actuator, and a booster actuator coupled with the valve and the actuator. The booster actuator includes a body, an actuation pin to translate from a first position to a second position responsive to an input force from the actuator, one or more springs in the body; and one or more cam assemblies coupled with the body and are configured to engage with the actuation pin. Responsive to translation of the actuation pin from the first position to the second position, the cam assemblies release the springs, thereby releasing energy in the body that increases an output force of the booster actuator relative to the input force from the actuator.

### CROSS-REFERENCE TO RELATED APPLICATIONS

The present disclosure claims the benefit of and priority to U.S. Provisional Application No. 63/491,394, filed Mar. 21, 2023, the disclosure of which is incorporated herein by reference in its entirety.

### BACKGROUND

The present disclosure relates generally to fire suppression systems. More specifically, the present disclosure relates to a booster actuator for actuating high pressure container valves with low force actuators in a fire suppression system.

Fire suppression systems can be activated manually or automatically in response to an indication that a fire is present nearby (e.g., an increase in ambient temperature beyond a predetermined threshold value, etc.). Fire suppression systems commonly utilize high pressure containers. Once activated, fire suppression systems spread a fire suppression agent throughout an area. The fire suppressant agent then extinguishes or controls the fire.

### SUMMARY

At least one aspect relates to a pressurized tank assembly for a fire suppression system. The pressurized tank assembly includes a storage tank configured to store a pressurized fluid and a valve operatively coupled with the storage tank, the valve being configured to open and release the pressurized fluid. The pressurized tank assembly also includes a booster actuator coupled with the valve and configured to receive an input from an actuator and actuate the valve. The booster actuator includes a body with a first end defining a first aperture and a second end opposite the first end, the second end defining a second aperture, an actuation pin configured to translate within the first aperture between a first position and a second position, the actuation pin defining a first recessed surface, at least one cam assembly, the cam assembly including a cam rotatably coupled with the body, a first bearing located on a first end of the cam, the first bearing configured to engage the first recessed surface when the actuation pin is in a second position, and a second bearing located on a second end of the cam opposite the first end of the cam, an actuation spring housed within the body, wherein the actuation spring is preloaded, and an actuation shaft configured to translate within the second aperture, the actuation shaft including a second recessed surface configured to engage the second bearing while the actuation spring is in a compressed state, wherein when the actuation pin is in a second position, the first bearing engages the first recessed surface causing the cam to rotate and disengage the second bearing from the second recessed surface. An actuator is operatively coupled with the booster actuator configured to apply a force to the actuation pin of the booster actuator.

At least one aspect relates to a booster actuator for a fire suppression system. The booster actuator includes a body including a first end defining a first aperture and a second end opposite the first end, the second end defining a second aperture, an actuation pin configured to translate within the first aperture between a first position and a second position, the actuation pin defining a first recessed surface, at least one cam assembly, the cam assembly rotatably coupled with the body and including a first bearing located on a first end of the cam, the first bearing configured to engage the first recessed surface when the actuation pin is in a second position and a second bearing located on a second end of the cam opposite the first end of the cam, an actuation spring housed within the body, wherein the actuation spring is preloaded, and an actuation shaft configured to translate within the second aperture, the actuation shaft including a second recessed surface configured to engage the second bearing while the actuation spring is in a compressed state. When the actuation pin is in a second position, the first bearing engages the first recessed surface causing the cam to rotate and disengage the second bearing from the second recessed surface.

At least one aspect relates to a booster actuator for a fire suppression system, including a body; an input shaft received by the body and configured to receive an input force; a spring received by the body and configured to move from a loaded position to an unloaded position to provide a spring force based on the input shaft receiving the input force; an output shaft received by the body and configured to receive the spring force and provide an output force greater than the input force; and a cam assembly coupled with the body and configured to retain the spring in the loaded position until the input force is received by the input shaft.

At least one aspect of the present disclosure relates generally to a tank assembly for a fire suppression system includes a storage tank to store a fire suppressant, a valve coupled with the storage tank, the valve to release the fire suppressant, an actuator, and a booster actuator coupled with the valve and the actuator. The booster actuator includes a body, an actuation pin to translate from a first position to a second position responsive to an input force from the actuator, one or more springs in the body; and one or more cam assemblies coupled with the body and are configured to engage with the actuation pin. Responsive to translation of the actuation pin from the first position to the second position, the cam assemblies release the springs, thereby releasing energy in the body that increases an output force of the booster actuator relative to the input force from the actuator.

Various aspects of the present disclosure relate to a tank assembly for a fire suppression system. The body includes a first end and a second end, wherein the first end defines a first aperture, and the second end defines a second aperture. The actuation pin can translate between the first position and the second position within the first aperture. The cam assemblies can further include a cam, a first bearing, and a second bearing. The first bearing is located on a first end of the cam and can engage with the actuation pin. The second bearing is located on a second end of the cam opposite the first end of the cam. The actuation pin defines a first recessed surface configured to engage with the first bearing and a second recessed surface configured to engage with the second bearing. The one or more cam assemblies are rotatably coupled with the body such that the one or more cam assemblies rotate, responsive to translation of the actuation pin from the first position to the second position, to release the springs. The tank assembly further can include an actuation shaft that translates within the body. The actuation shaft can engage a bearing on the cam assembly while the actuation pin is in a first position. The actuator can receive an electrical signal to open or close the valve from a control panel. Alternatively, the actuator can receive a manual signal to open or close the valve from a mechanical member.

At least one aspect relates to a booster actuator for a fire suppression system. The booster actuator includes a body, an input shaft, a spring, an output shaft, and a cam assembly couplet with the body. The input shaft can receive an input force. The spring is received by the body and can move from a loaded position to an unloaded position to provide a spring force based on the input shaft receiving the input force. The output shaft received by the body and can receive the spring force and provide an output force greater than the input force. The cam assembly is coupled with the body and configured to retain the spring in the loaded position until the input force is received by the input shaft.

Various aspects relate to a booster actuator for a fire suppression system. The booster actuator includes a cam assembly. The cam assembly includes a support member, a first bearing coupled with a first end of the support member, and a second bearing coupled with a second end of the support member, the second end opposite the first end. The cam assembly is coupled with the body by a pin, and the cam assembly is configured to rotate about the pin when the input force is received by the input shaft. The input shaft defines a first engagement surface, and the cam assembly engages the first engagement surface when the input force is received by the input shaft. The output shaft defines a second engagement surface, and the cam assembly disengages the second engagement surface when the input force is received by the input shaft. The input force is transmitted by an actuator that is separate from the booster actuator.

At least one aspect of the present disclosure relates generally to a booster actuator for a fire suppression system. The booster actuator includes a body that includes a first end defining a first aperture, and a second end opposite the first end, the second end defining a second aperture. The booster actuator includes an actuation pin configured to translate within the first aperture between a first position and a second position, the actuation pin defining a first recessed surface. The booster actuator includes at least one cam assembly. The cam assembly includes a cam rotatably coupled with the body, a first bearing located on a first end of the cam, the first bearing configured to engage the first recessed surface when the actuation pin is in a second position, and a second bearing located on a second end of the cam opposite the first end of the cam. The booster actuator includes an actuation spring housed within the body, wherein the actuation spring is preloaded. The booster actuator includes an actuation shaft the can translate within the second aperture, the actuation shaft including a second recessed surface that can engage the second bearing while the actuation pin is in the first position. As actuation pin moves from the first position to the second position, the cam rotates such that the first bearing engages the first recessed surface, and the second bearing disengages from the second recessed surface to enable the actuation shaft to move to an actuated position.

Various aspects relate to a booster actuator for a fire suppression system. The booster actuator includes a body that includes one or more O-rings. The body further includes a stopper that limits a distance an actuation shaft can move when moving into the actuated position. The body further includes a cam assembly coupled with the body by a pin, such that the cam assembly rotates about the pin when the actuation pin moves from the first position to the second position.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is schematic of an example of a fire suppression system.

FIG. 2 is a perspective view of an example of a tank assembly of the fire suppression system of FIG. 1.

FIG. 3 is a side view of a booster actuator of the tank assembly of FIG. 2, according to an exemplary embodiment.

FIG. 4 is a section view of the booster actuator of FIG. 3, according to an exemplary embodiment.

FIG. 5 is a perspective view of the booster actuator of FIG. 3, according to an exemplary embodiment.

FIG. 6 is an exploded view of the booster actuator of FIG. 3, according to an exemplary embodiment.

FIG. 7 is an example of a process for operating the fire suppression system of FIG. 1.

### DETAILED DESCRIPTION

Following below are more detailed descriptions of various concepts related to, and implementations of pilot valves for fire protection systems (e.g., sprinkler systems), including dual interlock pilot valves. The various concepts introduced above and discussed in greater detail below can be implemented in any of numerous ways, including in dry systems and in wet systems, such as to selectively control activation of flow control valves responsive to detection of a fire condition (e.g., responsive to pressure changes resulting from sprinklers opening to allow air or fluids in the system to be outputted; responsive to electronic actuation of one or more actuators or valves based on detecting the fire condition using temperature, heat, gas, smoke, or other sensors).

### Overview

Water is commonly used in fire suppression systems that suppress fires in different types of areas (e.g., office buildings, homes, schools, etc.). Water may be effective at extinguishing fires fueled by common flammable materials such as wood, paper, and cloth. However, in certain scenarios, water may be undesirable for use as a fire suppressant agent. When extinguishing fires near certain types of objects, such as books or electronic components, exposure to water can damage the objects that the fire suppression system is designed to protect. Accordingly, in certain environments, such as power plants, telecommunications facilities, aircraft, transport, data centers, medical facilities, and museums, application-specific chemicals are used to suppress fires instead of and/or in addition to water. These chemicals can suppress or control fires without causing damage to sensitive objects or requiring extensive clean-up.

Chemical fire suppression systems can include a pressure vessel or tank containing a pressurized fire suppressant agent, such as an inert gas (e.g., nitrogen, argon), a halocarbon, or carbon dioxide. A valve or actuator controls the flow of agent from the tank. When the actuator is activated, the agent flows outside of the tank, travelling along a length of pipe to one or more nozzles. The nozzles disperse the agent into the surrounding area (e.g., into a room or space). The agent reduces the concentration of oxygen in the room and/or reduces the heat of any items that are burning, extinguishing the fire.

Some fire suppression systems can use up to 300 bar of pressurized gasses to suppress fire or lower the oxygen levels of a fire. With higher pressures, it can be difficult to actuate the fire suppression system because of the force required to open the valve. Lower cost, lower force actuators, such as 12/24 volt electric actuators, often cannot generate sufficient force to actuate these valves. High force actuators generate sufficient force to actuate these valves, however, these high force actuators can be large and expensive.

### Fire Suppression System

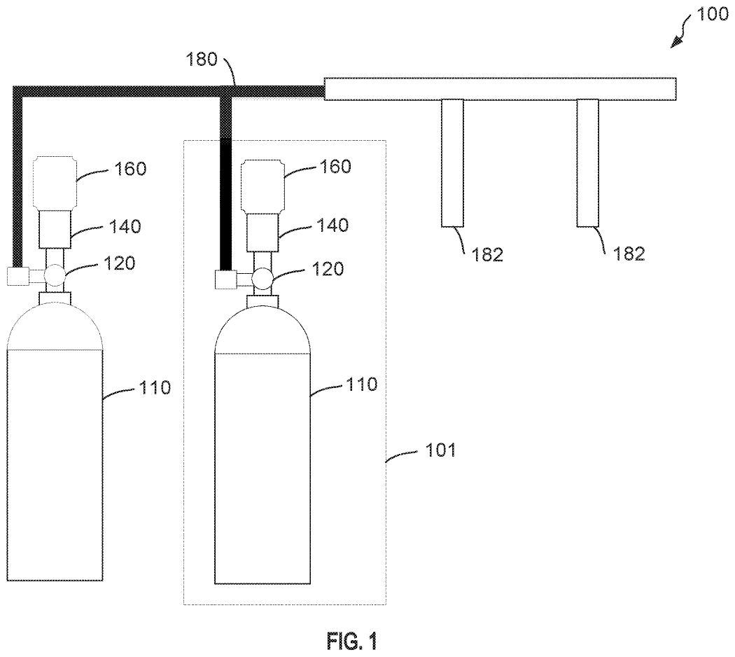

FIG. 1 shows an example of a fire suppression system 100. The fire suppression system 100 can dispense or distribute a fire suppressant agent onto and/or around a fire within a space, controlling or suppressing the fire. The fire suppression system 100 can be used alone or in combination with other types of fire suppression systems (e.g., a building sprinkler system, a portable fire extinguisher, etc.). Multiple fire suppression systems 100 can be used in combination with one another to cover a larger area.

The fire suppression system 100 can be a clean agent system that suppresses fires within a space while limiting damage to nearby assets. The fire suppression system 100 may utilize a clean agent, such as an inert gas (e.g., nitrogen, argon, etc.), a halocarbon agent, or carbon dioxide. Such clean agents can be stored as a superpressurized liquid configured to vaporize upon discharge, absorbing heat from the fire and/or from items that are fueling the fire to suppress or control the fire. By way of example, to bring the agent to a superpressurized state, the agent can be pressurized to the point of condensation into a liquid, and additional gas that condensates at a higher pressure can be added to further pressurize the agent. After absorbing heat, the agent can evaporate. The clean agents can be stored as a gas. The agent can reduce the concentration of oxygen within the space, extinguishing the fire. Both liquid and gaseous clean agents may suppress fires without leaving a residue that requires cleanup. The agents can be electrically non-conductive. Various such properties can make clean agents useful in applications where delicate and/or valuable items or information are stored. For example, the fire suppression system 100 can be used to protect telecommunication sites, data centers, archives, museums, oil and gas facilities, power plants, or other areas. The fire suppression system 100 utilizes other types of agents.

Referring again to FIG. 1, the fire suppression system 100 can include at least one tank assembly 101 (e.g., a container assembly, reservoir assembly, etc.), a pipe 180 (e.g., a conduit, etc.), and nozzles 182. Responsive to actuation of the tank assembly 101, a fire suppressant agent is forced into the pipe 180 (e.g., conduit, tube, hose, etc.). The pipe 180 can be an assembly including one or more straight or bent sections of conduit and/or one or more fittings. The pipe 180 can be fluidly coupled with nozzles 182 (e.g., outlets, sprayers, etc.). The fire suppressant agent flows through the pipe 180 and the nozzles 182. The nozzles 182 can each define one or more apertures, through which the fire suppressant agent exits, forming a spray of fire suppressant agent that suppresses or extinguishes fire within an area.

The tank assembly 101 can include one or more of a fire suppressant tank 110, a valve 120, a booster actuator 140, and an actuator 160. The fire suppressant tank 110 (e.g., vessel, container, vat, drum, tank, canister, cartridge, or can, etc.) stores a pressurized fire suppressant agent. The fire suppressant tank 110 can be selectively fluidly coupled with the pipe 180 and the valve 120 (e.g., a mechanically actuated valve, electrically-actuated valve, pneumatically actuated valve, etc.). The valve 120 can be operably coupled with the booster actuator 140 and/or the actuator 160. Responsive to being activated, the actuator 160 can generate a force to open the valve 120 and allow for fire suppressant agent to flow from the fire suppressant tank 110 into the pipe 180.

Tanks containing high-pressure fire suppressant agents generally require a higher force to actuate the tank's valve from a closed position into an open position. The booster actuator 140 can receive and increase an actuation force from the actuator 160 to be greater than an actuation threshold, such as to be sufficient to open valves 120 used for relatively high-pressure fire suppressant agent. The booster actuator 140 may be coupled with an existing and/or already installed actuator (e.g. the actuator 160) to increase the force output of the actuator. In this way, the booster actuator allows high pressure fire suppressant tanks, that the existing actuator would not otherwise be able to open, to be installed in existing fire suppression systems. Advantageously, this allows users to utilize higher pressure fire suppressant agents in their existing fire suppression systems, without needing to replace the parts of the existing fire suppression system.

The fire suppression system 100 can include or be coupled with a fire detection system. The fire detection system includes a controller. The actuator 160 is operatively coupled with the controller. For example, the controller can be operatively coupled with a user input device and manually activated. In response to receiving a user input or manual signal (e.g. a push of a button, a pull of a lever, etc.) when a user detects a fire, the user input device sends an activation signal to the controller, causing the controller to activate the actuator 160 to spread the fire suppressant agent into the pipe 180. The controller is further coupled with one or more sensors (e.g., an optical sensor, temperature sensor, or smoke detector, etc.) that can detect the presence of a fire. In response to detecting a fire, the sensor sends an activation signal to the controller, causing the controller to activate the actuator 160. For example, a smoke detector may sense smoke and send an electrical activation signal to the controller. The controller can verify the smoke detector's reading and send a delayed signal to the actuator 160 (e.g., 30 seconds, 1 minute, 2 minutes, etc.). In this example, the actuator 160 is activated and fire suppression gas and/or fluid is released after the delay. In this way, the building occupants may evacuate the area in which the fire suppression gas and/or fluid will be released.

The activation signal to the actuator 160 can be an electrical signal. For example, the controller can send voltage to the actuator responsive to user input or sensor input. Alternatively, the activation is or causes a flow of pressurized fluid or a movement of a mechanical member (e.g., a cable, lever etc.). In this way, a user can activate the fire suppression system without use of a central controller (e.g., by pulling a lever, cable, etc.). Responsive receiving an activation signal, whether it is electrical or mechanical, the actuator 160 activates, engaging the booster actuator 140 and fluidly coupling the fire suppressant tank 110 to the pipe 180.

### Tank Assembly

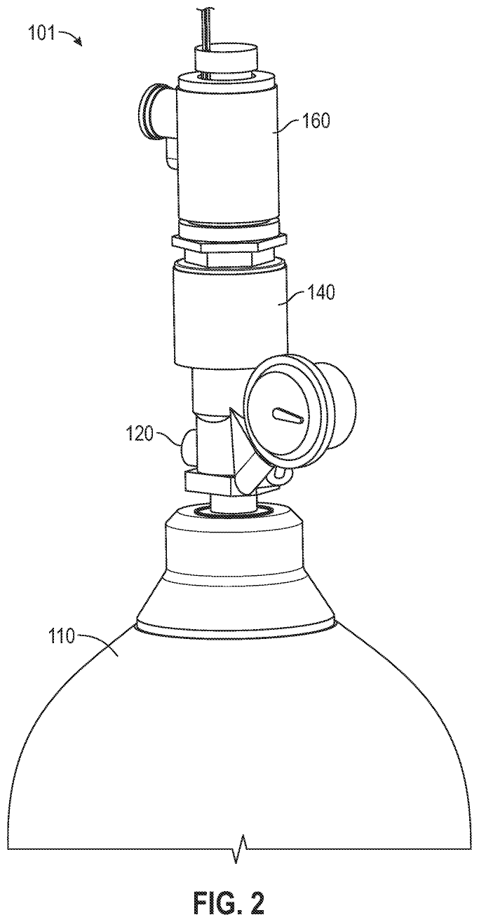

FIG. 2 is a perspective view of a tank assembly 101 of the fire suppression system 100 of FIG. 1, according to one embodiment. The fire suppressant tank 110 is selectively fluidly coupled with a pipe and nozzles through the valve 120. The size of the fire suppressant tank 110 may be application-specific and can be tailored based on design parameters to provide adequate fire suppression for a particular space. The valve 120 moves from a closed position to an open position when the actuator 160 is activated. The valve 120 may be mechanically or electrically actuatable between the closed position and the open position. The actuator 160 can receive an activation signal from a controller from a fire detection system or a manual activation signal from a user (e.g., via a mechanical member such as a cable, lever etc.). Responsive to activation, the actuator 160 operates valve 120, moving it from a closed position into the open position. When the valve 120 is opened (e.g., responsive to an activation signal and actuation by actuator 160), a fire suppressant agent stored in the fire suppressant tank 110 can flow out of the fire suppressant tank 110 through the pipes and nozzles. In this way, the fire suppressant tank is fluidly coupled with the fire suppression system pipes and nozzles via the open valve.

The valve 120 may require varying levels of force to open. For example, in high-pressure fire suppressant systems, the force required to open a valve is high, and traditional actuators (e.g., actuator 160) may not generate enough force to open the valve. The booster actuator 140 is operably coupled between the valve 120 and the actuator 160 and can increase the amount of force generated by the actuator 160 to open the valve 120 relative to a tank system having a traditional valve-actuator system (e.g. a valve coupled to a latching solenoid actuator, a direct-acting solenoid actuator, etc.), thereby reducing the force needed from the actuator 160 to actuate the valve 120. The actuator 160 can be coupled with the booster actuator 140 in various manners, such as to be threaded to the top of the booster actuator 140.

### Booster Actuator

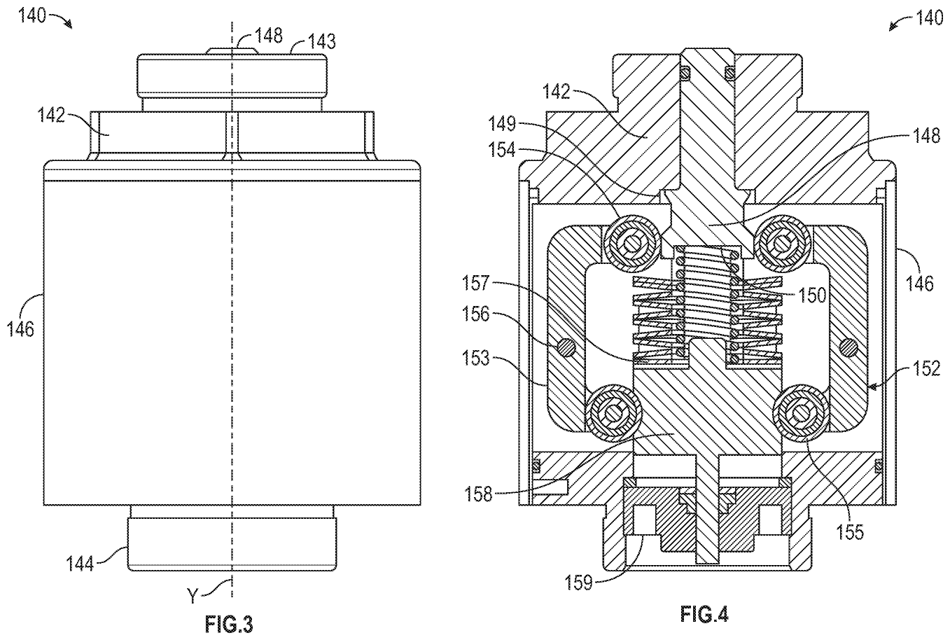

Referring generally to FIGS. 3-6, booster actuator 140 includes a body 142. The body can include an actuator coupling 143 and a valve coupling 144. The booster actuator 140 can include a housing 146 and an actuation pin 148 (e.g., an input shaft, a first shaft, etc.). The actuation pin 148 includes a recessed surface 149 (e.g. a first engagement surface). The booster actuator 140 further includes a support spring 150 and one or more cam assemblies 152. The cam assembly 152 includes a cam 153, a first bearing 154, a second bearing 155, and a pin 156. The booster actuator 140 also includes an actuation spring 157, an actuation shaft 158 (e.g., an output shaft, a second shaft), and a stopper 159.

FIG. 3 is a side view of the booster actuator 140 of FIG. 2. As depicted in FIG. 3, the housing 146 is connected to the body 142. The housing 146 is disposed around the body 142 and can have an internal volume to at least partially hold one or more components of the booster actuator 140.

The body 142 includes the actuator coupling 143 at one end and a valve coupling 144 at the other.

The actuator coupling 143 is selectively coupled (e.g., threaded assembly, fasteners, etc.) to the actuator 160, and can receive a stem or other input feature from the actuator 160. The actuator coupling 143 may be sized (e.g., diameter, thread shape, thread pitch, etc.) to engage with the actuator 160. Responsive to being activated (e.g., by the controller, by a mechanical member, by user input, etc.), the actuator 160, can generate a force that is applied to the actuation pin 148, such as to a first end (e.g. the end closest to the actuator 160) of the actuation pin 148. The actuation pin 148 is disposed within the actuator coupling 143 receives force inputs from the actuator 160. Responsive to receiving a force input from the actuator 160 the actuation pin 148 moves axially in a downward direction between a first position and second position. For example, responsive to a control signal the actuator 160 applies a downward force on the first end of the actuation pin 148, causing the actuation pin to move out of its first position by rotating about its second end (e.g., the end closest to the valve 120) into a second position.

The body 142 is coupled with the valve 120 using a valve coupling 144 the end opposite to the actuator coupling 143. The valve coupling 144 is selectively coupled (e.g., threaded assembly, fasteners, etc.) to the valve 120, and can actuate the valve 120 via the actuation shaft 158 (e.g. the output shaft). The valve coupling 144 may be sized (e.g., diameter, thread shape, thread pitch, etc.) to engage with the valve 120. The actuation pin's 148 first position corresponds to a valve closed position (e.g., valve 120), and the second position corresponds to a valve open position. In the second position the valve 120 is opened by the combined force of the booster actuator 140 and the actuator 160, thereby allowing the fire suppressant tank 110 to release a fire suppressant agent.

FIG. 4 is a cross-sectional view of the booster actuator 140 of FIG. 2 along axis Y, according to one embodiment. As seen in FIG. 4, the actuation pin 148 lowers and moves into the second position responsive to activation of the actuator 160. In the second position the actuation pin 148 compresses the support spring 150. The support spring 150 is coaxially aligned with the actuation pin 148 and supports the actuation pin 148 such that it is held in the first position.

The booster actuator 140 can include one or more cam assemblies 152 that hold one or more actuation springs 157 in preloaded position (e.g., compressed relative to its natural state). The cam assemblies 152 and the actuation springs 157 are disposed around the support spring 150. The actuation springs may be coaxial with a support shaft 158 and the support spring 150, whereas the cam assemblies may abut the actuation pin 148 on a first end and the support shaft 158 on a second end. The cam assemblies 152 are movable within the housing of the booster actuator, such that they may move off of and away from the actuation springs 157. In this way, the cam assemblies control the compression and release of the actuation springs 157. The release of the actuation springs 157 also releases energy that allows the booster actuator to increase the input force of the actuator 160. This increase of force by the booster actuator allows the actuator 160 to open valves on high pressure fire suppression systems, in which a singular traditional actuator (e.g., latching solenoid actuator, a direct-acting solenoid, etc.) may not have enough power to open. The booster actuator 140 can include various numbers of cam assemblies 152, depending on the force needed to open a fire suppression tank valve. As an example, as depicted in FIGS. 4 and 6, the booster actuator 140 can include four cam assemblies 152. In such example, the four cam assemblies can hold four actuation springs in preloaded positions.

The cam assembly 152 includes a cam 153 coupled with a first bearing 154 on one end proximate the actuator coupling 143, and a second bearing 155 on the opposite end proximate the valve coupling 144. The cam 153 and the bearings (first bearing 154 and the second bearing 155) are coupled with the body 142 by the pin 156. The cams 153 can rotate about the pin 156 responsive to the actuation pin 148 (e.g. the input shaft), thereby moving from a first position into a second position. The second bearing 155 is engaged with the actuation shaft 158 through an annular groove or other feature that can hold the second bearing 155 in place until the actuation pin 148 moves to the second position (e.g. second recessed surface, a second engagement surface, etc.), thereby compressing the support spring 150. Upon rotation of the cam assemblies 152 rotating about the pins 156, the cam 153 is moved off of the actuation spring 157 that it holds into a compressed (i.e., a preloaded) position.

Responsive to a force input from the actuator 160, the actuation pin moves into the second position (e.g., is lowered). The actuation pin 148 defines a recessed surface 149 (e.g. an annular groove, a first engagement surface, etc.) that can engage the first bearing 154. Responsive to the actuation pin 148 moving into the second position, the second bearing 155 moves radially outward from the actuation shaft 158 as the first bearing 154 engages with the recessed surface 149 of the actuation pin 148. The first bearing 154 moves inward towards the actuation pin 148. The actuation pin 148 includes a recessed surface 149 that moves can receive the first bearing 154 due to the second bearing 155 rotating outward relative to actuation shaft 158.

The actuation springs 157 are preloaded (e.g., compressed relative to its natural state), by the cam assemblies 152 thereby storing potential energy. Responsive to rotation of the cam assembly 152, the actuation spring 157 can be released from its compressed position. When released, the potential energy of the actuation spring 157 is transferred in the form of kinetic energy to the actuation shaft 158, increasing the initial force input from the actuator 160. The force of the actuation spring 157 acts on the actuation shaft 158 to drive the actuation shaft 158 towards the valve 120, thereby opening the valve 120 at an increased force relative to the input force of the actuator. The actuation shaft 158 travels a distance determined by the stopper 159.

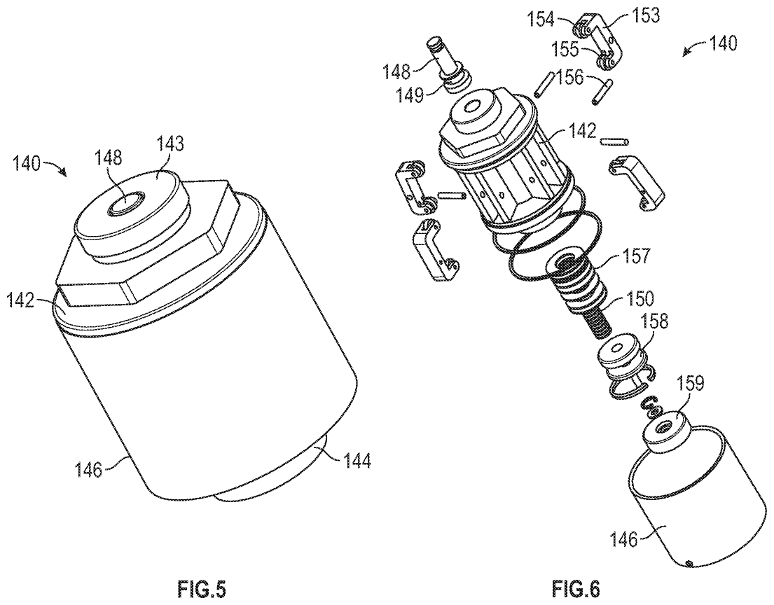

FIG. 5 is a perspective view of the booster actuator 140 of FIG. 2, according to one embodiment. In FIG. 5, the housing 146 is a cylindrical tube. The housing 146 can be a tube of a different cross-sectional shape with any number of sides. The housing 146 is located around a portion of the body 142. In some embodiments, the housing 146 is formed as a single piece. In some embodiments, the housing 146 is made from multiple pieces coupled (e.g., fixedly coupled, welded, adhered, fastened, etc.) to one another. In some embodiments, the housing is rigid (e.g., aluminum, steel, plastic). In some embodiments, the housing 146 is substantially sealed, and may include a sealing member, such as an O-ring, or gasket.

The body 142 extends out of a top opening of the housing 146 and a bottom opening of the housing 146. The body 142 includes an actuator coupling 143 on one end that can couple the body 142 to an actuator, such as the actuator 160 of FIG. 1. The actuator coupling 143 is selectively coupled (e.g., threaded assembly, fasteners, etc.) to the actuator 160. The actuator coupling 143 can include an extruded portion matching the shape of a recessed portion of an actuator. The actuator coupling 143 can protrude vertically from the body 142. Alternatively, the actuator coupling 143 may be a separate component coupled with the body 142, such as through a threaded assembly. The actuator coupling 143 may include one or more alignment features can align and engage the actuator 160. The alignment features can prevent rotation and/or relative movement between the booster actuator 140 and the actuator 160.

The body 142 also includes a valve coupling 144 on one end opposite to the actuator coupling 143. The valve coupling 144 is can couple the body 142 with a valve, such as the valve 120 of FIG. 1. The valve coupling 144 is selectively coupled (e.g., threaded assembly, fasteners, etc.) with the valve 120. The valve coupling 144 can comprise an extruded portion matching the shape of a recessed portion of a valve. The valve coupling 144 can protrude vertically from the body 142. Alternatively, the valve coupling 144 may be a separate component coupled with the body 142, such as through a threaded assembly. The valve coupling 144 may include one or more alignment features to align and engage the valve 120. The alignment features may prevent rotation and/or relative movement between the booster actuator 140 and the valve 120.

The body 142 includes an aperture in which the actuation pin 148 is located. The aperture is located in the actuator coupling 143. The actuation pin 148 can receive an actuation force from the actuator 160 and translate into the body 142, thus activating the booster actuator 140. The top surface of the actuation pin 148 can be positioned, when not receiving the actuation force, flush with the top surface of the body 142. The actuation pin 148 can be located in a portion of the actuator coupling 143 that extends into the actuator when the booster actuator 140 is operably coupled with an actuator. The actuation pin 148 is coupled with the body 142 such that it seals, such as through a groove and O-ring.

FIG. 6 is an exploded view of the booster actuator 140 of FIG. 2, according to one embodiment. FIG. 6 depicts the body 142 which includes an aperture for housing the actuation pin 148 and channels for housing the cam assemblies 152. The body 142 may have various numbers of cam assemblies and channels therein. For example, the body 142 can include four internal cam assemblies 152 and four channels therein. The cam assemblies 152 can be evenly spaced around the vertical axis of the body 142. The booster actuator 140 can include any number of cam assemblies (e.g., 1, 2, 3, 4, 10, 15, 20, etc.). The cam assemblies 152 operably couple with the body 142 via pins 156 that allow for the cams 153 of the cam assemblies 152 to rotate about the pins 156. The pins 156 couple the cam assemblies with the body 142 by passing through pin apertures on the body 142 and pin apertures on the cam assemblies 152. The pins 156 can include a locking mechanism (e.g., fastener, secondary pin, etc.) to prevent the pin 156 from dislocating during operation.

The body 142 can include one or more O-rings. The O-rings can be can form a press fit between the housing 146 and body 142. The O-rings can additionally seal the booster actuator 140 from outside fluids. The body 142 also houses the support spring 150 (e.g., a coil spring, etc.) which is coaxial with the aperture that accepts the actuation pin 148. The support spring 150 supports the actuation pin 148 above the first bearings 154 of the cam assemblies 152, thus preventing the cam assemblies 152 from rotating until the actuation pin 148 receives an actuation force from the actuator 160. The actuation pin 148 may include a seat to hold and align the support spring 150.

Coaxial with the support spring 150 is the actuation spring 157 (e.g., a coil spring, one or more wave springs or washers, etc.). The actuation spring 157 is housed in the body 142 in a preloaded position (e.g., in a position that stores potential energy) until an actuation force releases the actuation spring 157. The actuation spring 157 is coaxial with the actuation shaft 158. The second bearings 155 of the cam assemblies 152 and actuation shaft 158 are held in place before the actuation pin 148 receives the actuation force. The actuation shaft 158 includes an annular groove that can receive second bearings 155 in the cam assemblies 152. The actuation spring 157 decompresses responsive to the actuation force and pushes the actuation shaft 158 axially away from the actuation pin 148 with an increased force relative to the input force of the actuator 160.

The actuation shaft 158 can include a boss extending vertically towards the center of the booster actuator 140 to hold and align the support spring 150 and/or the actuation spring 157. The difference between the diameter of the boss and the diameter of the support spring 150 can hold the support spring in place. The actuation shaft 158 can include a pin member extending vertically towards the valve 120 that may open the valve 120. The actuation shaft 158 is stopped by the stopper 159, located coaxially to the actuation shaft 158 and opposite the actuation spring 157. The stopper 159 can limit the distance the actuation shaft 158 travels during operation. Additionally, the stopper 159 can be selectively coupled (e.g., via a threaded assembly, a fastener, etc.) to the body 142 to allow for the booster actuator 140 to be assembled. The booster actuator 140 can include additional spacers (e.g., washers, etc.) and/or seals to configure the booster actuator 140 for a specific usage. For example, spacers can be used to extend the distance the actuation shaft 158 travels during operation.

The booster actuator 140 can include additional hardware (e.g., washers, springs, O-rings, gaskets, etc.) that facilitates the coupling between components of the booster actuator 140. The additional hardware can be added, removed, and/or replaced based on the configuration and/or function of the booster actuator 140.

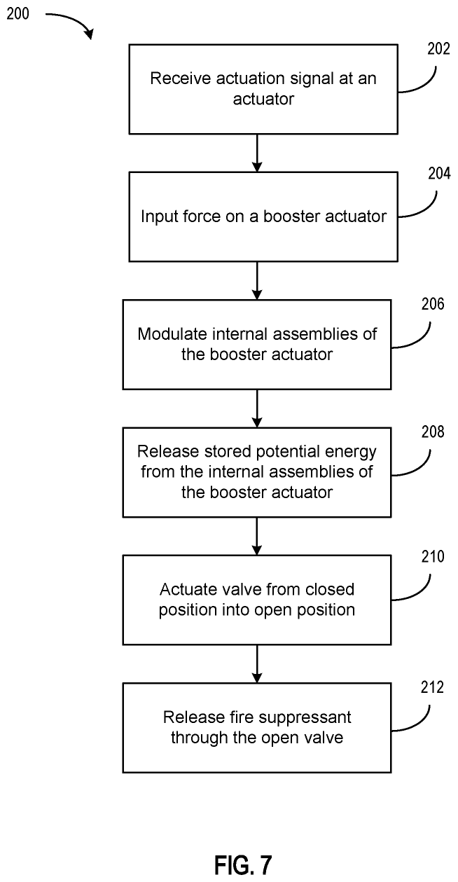

Referring to FIG. 7, an exemplary actuation process for the fire suppression system of FIG. 1. The process 200 may begin by receiving an actuation signal at an actuator (e.g., actuator 160)(step 202). The actuation signal can be an electrical signal from a fire control panel, a building management system, a sensor, or anything of the like. Alternatively, the actuation signal may be manual. For example, the actuation signal may be a user operating a mechanical element, such as a lever, a pull cable, or anything of the like. Responsive to receiving the actuation signal, the actuator (e.g., the actuator 160) inputs a force on a booster actuator (e.g., booster actuator 140) (step 204). The input force causes modulation of the booster actuator's internal assemblies (step 206). The modulation may include lowering the actuation pin 148 and rotating the cam assemblies 152. Responsive to the lowering of the actuation pin 148 and the rotation of the cam assemblies, the actuation springs 157 are released from their preloaded position, thereby releasing stored potential energy (step 208). The release of the stored potential energy from the booster actuator at step 208 increases the initially input force of the actuator from step 204. This allows the actuator in combination with the booster actuator to actuate a valve from a closed position to an open position (step 210). The open valve allows for the release of fire suppressant (e.g., liquid, gas, foam, etc.) from a pressurized tank (step 212). Once open, fire suppressant may move from the tank through the pipes and nozzles of the fire suppression system.

### Configuration of Exemplary Embodiments

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the booster actuator as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A tank assembly for a fire suppression system comprising:
a storage tank to store a fire suppressant;
a valve coupled with the storage tank, the valve to release the fire suppressant;
an actuator;
a booster actuator coupled with the valve and the actuator, the booster actuator comprising:
a body;
an actuation pin to translate from a first position to a second position responsive to an input force from the actuator;
one or more springs in the body; and
one or more cam assemblies coupled with the body and are configured to engage with the actuation pin, wherein, responsive to translation of the actuation pin from the first position to the second position, the cam assemblies release the springs, thereby releasing energy in the body that increases an output force of the booster actuator relative to the input force from the actuator.

2. The tank assembly of claim 1, wherein the body comprises a first end and a second end, wherein the first end defines a first aperture and the second end defines a second aperture.

3. The tank assembly of claim 2, wherein the actuation pin is configured to translate between the first position and the second position within the first aperture.

4. The tank assembly of claim 1, wherein the cam assemblies further comprise:
a cam;
a first bearing located on a first end of the cam, the first bearing configured to engage with the actuation pin; and
a second bearing located on a second end of the cam opposite the first end of the cam.

5. The tank assembly of claim 4, wherein the actuation pin defines a first recessed surface configured to engage with the first bearing and a second recessed surface configured to engage with the second bearing.

6. The tank assembly of claim 1, wherein the one or more cam assemblies are rotatably coupled with the body such that the one or more cam assemblies rotate, responsive to translation of the actuation pin from the first position to the second position, to release the springs.

7. The tank assembly of claim 1 further comprising an actuation shaft configured to translate within the body.

8. The tank assembly of claim 7, wherein the actuation shaft is configured to engage a bearing on the cam assembly while the actuation pin is in the first position.

9. The tank assembly of claim 1, wherein the actuator receives an electrical signal to open or close the valve from a control panel.

10. The tank assembly of claim 1, wherein the actuator receives a manual signal to open or close the valve from a mechanical member.

11. A booster actuator for a fire suppression system, comprising:
a body;
an input shaft received by the body and configured to receive an input force;
a spring received by the body and configured to move from a loaded position to an unloaded position to provide a spring force based on the input shaft receiving the input force;
an output shaft received by the body and configured to receive the spring force and provide an output force greater than the input force; and
a cam assembly coupled with the body and configured to retain the spring in the loaded position until the input force is received by the input shaft.

12. The booster actuator of claim 11, wherein the cam assembly comprises:
a support member;
a first bearing coupled with a first end of the support member; and
a second bearing coupled with a second end of the support member, the second end opposite the first end.

13. The booster actuator of claim 12, wherein the cam assembly is coupled with the body by a pin, and the cam assembly is configured to rotate about the pin when the input force is received by the input shaft.

14. The booster actuator of claim 11, wherein:
the input shaft defines a first engagement surface; and
the cam assembly engages the first engagement surface when the input force is received by the input shaft.

15. The booster actuator of claim 11, wherein:
the output shaft defines a second engagement surface; and
the cam assembly disengages the second engagement surface when the input force is received by the input shaft.

16. The booster actuator of claim 11, wherein the input force is transmitted by an actuator that is separate from the booster actuator.

17. A booster actuator for a fire suppression system, comprising:
a body comprising:
a first end defining a first aperture; and
a second end opposite the first end, the second end defining a second aperture;
an actuation pin configured to translate within the first aperture between a first position and a second position, the actuation pin defining a first recessed surface;
at least one cam assembly, the cam assembly comprising:
a cam rotatably coupled with the body;
a first bearing located on a first end of the cam, the first bearing configured to engage the first recessed surface when the actuation pin is in a second position; and
a second bearing located on a second end of the cam opposite the first end of the cam;
an actuation spring housed within the body, wherein the actuation spring is preloaded; and
an actuation shaft configured to translate within the second aperture, the actuation shaft including a second recessed surface configured to engage the second bearing while the actuation pin is in the first position;
wherein as the actuation pin moves from the first position to the second position, the cam rotates such that the first bearing engages the first recessed surface and the second bearing disengages from the second recessed surface to enable the actuation shaft to move to an actuated position.

18. The booster actuator of claim 17, wherein the body further comprises one or more O-rings.

19. The booster actuator of claim 17, the body further comprises a stopper that limits a distance the actuation shaft can move when moving into the actuated position.

20. The booster actuator of claim 17, wherein the cam assembly is coupled to the body by a pin, such that the cam assembly rotates about the pin when the actuation pin moves from the first position to the second position.
